(19) United States
(12) Patent Application Publication
(10) Pub. No.: US 2015/0172327 A1
(43) Pub. Date: Jun. 18, 2015

(54) SYSTEM AND METHOD FOR SHARING PREVIOUSLY VISITED LOCATIONS IN A SOCIAL NETWORK

(71) Applicants: Andrew Theodore WANSLEY, San Francisco, CA (US); Kenneth Joseph Leftin, San Francisco, CA (US)

(72) Inventors: Andrew Theodore WANSLEY, San Francisco, CA (US); Kenneth Joseph Leftin, San Francisco, CA (US)

(73) Assignee: Google Inc., Mountain View, CA (US)

(21) Appl. No.: 13/615,426

(22) Filed: Sep. 13, 2012

(51) Int. Cl. H04L 29/06; G06F 17/30; G06F 3/0482; G06F 15/16; G06F 3/0484

(52) U.S. Cl. CPC H04L 65/403; G06F 3/04842; G06F 3/0482; G06F 17/30241

(57) ABSTRACT

A system and method for sharing previously visited locations in a social network includes a location-aware computing device (for example, a smartphone) configured to send, to a server, a historical log of data representative of a path previously travelled by a user. The server may determine one or more candidate places of interest along the previously travelled path based on the historical data, and provide the candidate places of interest to the user for selection. On the user selecting one or more of the displayed candidate places of interest, the server may provide the selected places of interest to a social network for display to other users in the social network, to inform the other users that the user visited those places.

### TECHNICAL FIELD

The subject technology relates generally to the location-aware and navigational devices.

### BACKGROUND

Location-aware smart phones and other devices have been integrated with interactive location services to provide users the ability to view their current locations, and the current locations of their friends, on interactive maps. In this manner, a user may load a map on a cell phone to view the current location(s) of the user's friends in real time. Location-aware devices may also be integrated with a “check-in” feature that enables a user to select, in real-time, a place of interest near the user's current geographic location to announce to other users (for example, in a social network) where the user is currently located.

### SUMMARY

The subject technology provides a system and computer-implemented method for sharing previously visited locations in a social network. According to one aspect, a computer-implemented method may include receiving historical travel data related to a path travelled by a user, determining one or more candidate places of interest along the travelled path based on the historical travel data, providing the one or more candidate places of interest for display to the user, receiving, from the user, one or more selected places of interest, selected from the one or more candidate places of interest, and providing, for display to other users of a social network, a representation of the user and the selected places of interest. Other aspects include corresponding systems, apparatuses, and computer program products for implementation of the computer-implemented method.

In another aspect, a machine-readable medium may include instructions stored thereon that, when executed by a processor, cause a machine to perform a method of displaying a geographically targeted internet offering. In this regard, the method may include receiving a plurality of geographic coordinate readings recorded over a period of time, the plurality of geographic coordinate readings related to a path travelled by a user, determining one or more candidate places of interest based on the plurality of geographic coordinate readings, providing the one or more candidate places of interest for display at a user interface, receiving, from the user interface, one or more selected places of interests, and providing, for display to users of a social network, a representation of the user and the selected places of interest. Other aspects include corresponding systems, apparatuses, and computer program products.

In a further aspect, a system may include a processor and a memory. The memory may include instructions that, when executed by the processor, cause the processor to receive a plurality of coordinate readings related to a path travelled by a user, determine one or more candidate places of interest along the travelled path based on the plurality of coordinate readings, provide the one or more candidate places of interest for display at a user interface, receive, from the user interface, one or more selected places of interest, and provide, for display to other users of a social network, a representation of the user and the one or more selected places of interest.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

A detailed description will be made with reference to the accompanying drawings:

FIG. 1 is a diagram of an example system for sharing previously visited locations in a social network.

FIG. 2 depicts a travel path determined from a plurality of example coordinate readings 202 received from a location-aware device associated with a user.

FIG. 3 depicts an example computing device, including a user interface for selecting previously visited locations.

FIG. 4 depicts a webpage, including example alternative viewing mechanisms for displaying locations previously visited by a user in a social network.

FIG. 5 is a flowchart illustrating an example process for sharing previously visited locations in a social network.

FIG. 6 is a diagram of an example system for sharing previously visited locations in a social network.

FIG. 7 is a diagram illustrating an example computing system for sharing previously visited locations in a social network, including a processor and other internal components.

### DETAILED DESCRIPTION

A location-aware device (for example, a GPS-enabled smart phone) may be integrated with a check-in feature that enables a user to send an indication (for example, an announcement, message, or the like) to other users in a social network that user is at, or was at, a place of interest (for example, a business establishment) at or near the user's current or past geographic location. As will be described further, the user may not required to be at a specific location to perform a check-in. Rather, the subject technology enables the user to perform a check-in to places of interest visited in the past, and to share those places of interest with other users in the social network as if the user had checked in to the places of interest while visiting them.

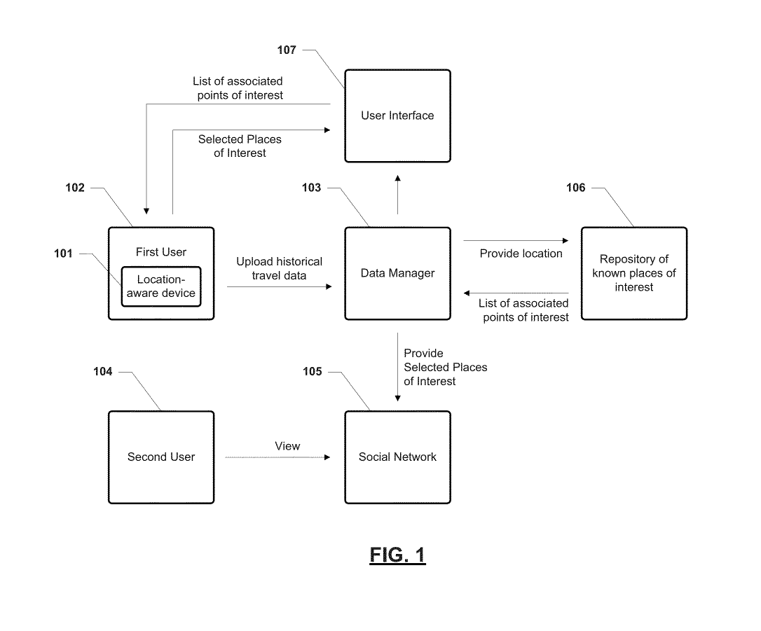

FIG. 1 is a diagram of an example system for sharing previously visited locations in a social network according to one aspect of the subject technology. A location-aware device 101 (for example, a GPS-enabled smartphone), associated with a first user 102, may be configured, on consent of its user, to record and store historical travel data (for example, a series of geographic coordinates, WiFi scans, cell tower information, or the like) as user 102 imparts on a journey. At the completion of the journey, device 101 may be configured to send (for example, upload, transmit, or the like) the historical travel data to a data manager 103 (for example, software running on device 101, a remote server, or the like) so that identified places of interest visited during the journey may be shared with one or more second users 104 in a social network 105.

In one example, device 101 includes one or more setup screens that enable the user to configure device 101 to temporarily collect historical travel data. In this regard, data is collected for the limited purpose of providing the user the ability to review and select places of interest previously visited by the user, and to perform a “check-in” to one or more selected places of interest after-the-fact. Historical travel data is encrypted and then stored for windows of predetermined periods of time (for example, the last 24 hours). During a journey, device 101 may periodically inform the user (for example, by way of a blinking icon on the device's display screen) that the device is collecting historical travel data. The setup screens may further enable the user to purge stored data, and/or disable further collection of travel data.

The historical travel data may include a series of geographic coordinate readings (for example, latitude/longitude, Cartesian coordinates, GPS data, or the like) recorded over a period of time (for example, prior to the user arriving at a current location). In this regard, data manager 103 receives the coordinate readings and determines one or more places of interest visited by the user at specific location points (for example, geographic locations or coordinates) along a travel path based on a predetermined rule. The predefined rule may, for example, involve clustering of the geographic coordinate readings to determine identifiable location points where the user spent time (for example, paused for a predetermined duration), determine one or more location points based on a pause in recording for a predetermined duration at a point in the travel path, or the like.

On determining one or more location points, data manager 103 may, for example, search a repository 106 for known places of interest (for example, businesses, recreation centers, or the like) proximate to the one or more location points (for example, within a predetermined distance). In one aspect, repository 106 may include a check-in service integrated with social network 105 (for example, provided by a third party). In this manner, data manager 103 may determine a location point and query the check-in service using the location point to retrieve candidate places of interest as if user 101 was checking in at a current location.

Candidate places of interest may be further limited by ranking places of interest known to be within a vicinity (for example, a radius) of a location point. In this manner, a higher ranking may be assigned to previously visited places of interest or places of interest similar to those previously visited. For example, if a user typically frequents bars, and a place of interest near a location point may be either a bar or a nearby acupuncture center, the system may determine that the candidate place of interest is more likely to be the bar. The number of possible candidate places of interest may be further limited by sweeping a radius around a determined geographic location. Additionally or in the alternative, one or more candidate places of interest may be selected based on a categorization. For example, a bar may include a “night” categorization and a hospital may include a “day” categorization. If a geographic location determined from the received coordinates is proximate to both, and the location was visited at night, the bar may be selected as the candidate place of interest.

Other signals that may be used to determine candidate places of interest may include places of interest that other people in the user's social graph have visited, a history of places of interest shared by other users, a predetermined global prominence score given to places of interest along the travel path, past web searches or web pages viewed by the user that are related to places of interest, and the like. Places of interest may also be determined by automatically detecting recognizable markers in photos uploaded to the system (including, for example, geographically encoded location information, recognizable visual marker, or the like).

Once a list of candidate places of interest is determined, data manager 103 may provide the candidate places of interest to a user interface 107 for selection by user 101. In some aspects, the previously described signals used to determine candidate places of interest may merely assist in ranking each candidate place of interest. In this regard, those places of interest having a higher ranking may appear first in a selection list displayed at user interface 107. At user interface 107, first user 102 may be presented with places of interest visited during the journey. First user 102 may then provide consent to share one or more of those places of interest with other second users 104 in the social network by selection of those places of interest at user interface 107. On receiving from user 101 one or more selected places of interest, a representation of the user and the selected (previously visited) places of interest may be provided for display in the social network. For example, the representation may include a character description of the one or more selected places of interest together with a user identifier such as the user's name, picture, or other likeness of the user. In one example, the representation may be a message posted to a message stream, viewable by other users in the user's social graph. In another example, the representation may include the user's name, picture, or other likeness displayed at one or more geographical locations on a map, together with information about the one or more selected places of interest.

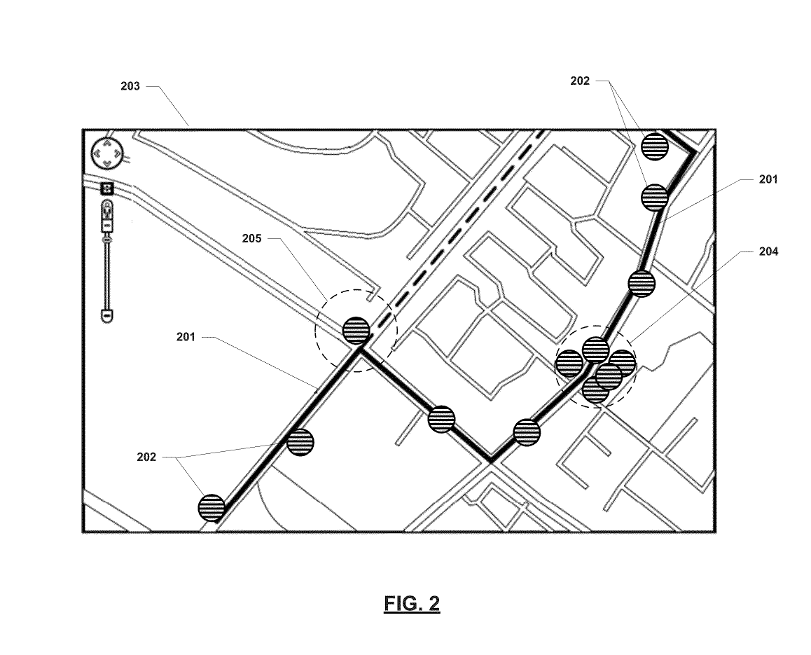

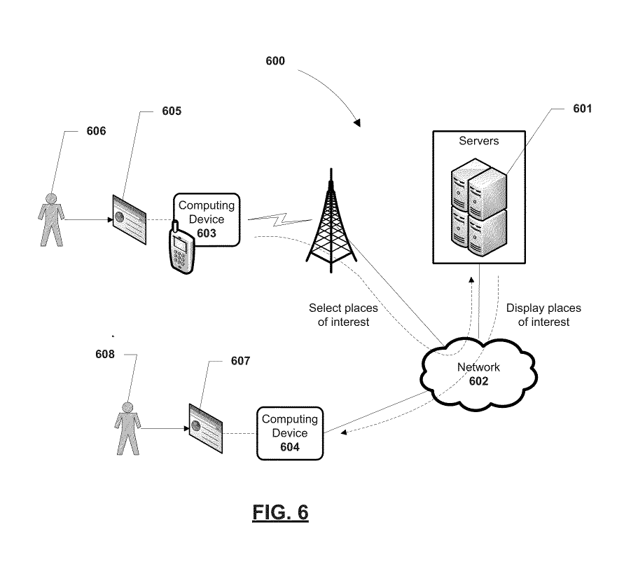

FIG. 2 depicts a travel path 201 determined from a plurality of example coordinate readings 202 received from a location-aware device associated with a user according to the subject technology. A location-aware device (for example, device 602 of FIG. 6, or the like) may capture geographic position information over a period of time, for example, as the device is moved along travel path 201. The position information may include one or more geographic coordinate readings 202 determined (for example, generated) and/or recorded by the location-aware device over a period of time, with each reading representative of a location of the device at a particular point in time. In some aspects, a coordinate reading may be determined by the device at periodic intervals. Travel path 201 may be constructed (for example, virtually) based on the location and sequence order of each of coordinates 202 by software (for example, data manager 103) running on the location-aware device, or a server, and stored for later use. In the depicted example, travel path 201 is displayed on an electronic map 203, which may be displayed by the computing device. In other aspects, travel path 201 may not be generated, but, rather, may be merely illustrative of geographic coordinates 202 received from a computing device.

Once received, geographic coordinates 202 may be translated to location points, with each location point representing a potential location where the user visited a place of interest. In some aspects, a location point may be determined from a cluster 204 of geographic coordinate readings 202 (for example, two or more points) around a geographic location in travel path 201. Cluster 204 of readings may provide an indication that the user of the device was stationary at a particular geographic location and, potentially, a place of interest. In this case, the software instructions may generate a location point to represent cluster 204 of geographic coordinate readings. In other aspects, a location point may be determined from, for example, one or more geographic locations 205 where the user paused for a predetermined duration along the travel path (for example, from a series of identical or substantially identical coordinate readings over a period of time).

The subject technology may determine one or more candidate places of interest for each determined location point. A candidate place of interest may include a business, a public recreation area (for example, a park, campground, pool, beach, or the like), government building, monument, tourist attraction, amusement park, or the like. In some aspects, a list of candidate places of interest may be determined for an area within a predetermined radius about the location point (or received coordinates). The candidate places of interest may then be ranked based on a number of different signals to facilitate determining which one or more of the candidate places of interest the user visited.

One signal may include a location history of the device, for example, past visits (for example, social media check-ins) to known locations or places. From the location history, the device may determine one or more candidate places of interest at the current location point that corresponds to a place in the user's location history, or places similar to those in the location history. For example, if the user has visited a candidate place of interest in the past, that candidate place of interest may more likely be the place of interest visited at the subject time in question. In another example, each candidate place may be associated with a classification corresponding to what type of place it is. The candidate place may then be evaluated based on the classification of places in the location history. For example, if the user typically frequents bars, and a place of interest may be a bar or a nearby acupuncture center, the system may determine that the place of interest is more likely to be the bar. A confidence score (for example, a normalized value or percentile, or the like) corresponding to each candidate place of interest may be determined based on how many times the user previously visited the candidate place or a place having a classification matching the candidate place of interest. For example, the confidence score may be 0.75 if the user visited the candidate place of interest two out the last three times the user was at the current location point, but 0.5 if the user has never visited the current location point.

Similarly, another signal may include places of interest associated with other users related through the user's social graph (“related users”). In this regard, a user may be expected to more likely associate with those places that related users have, for example, visited, endorsed, shared through the social network, or the like. The subject technology may retrieve a list of places from respective location histories of the related users, and select places near to the current location point of the user from that list to recommend places. For example, if one or more related users have visited one or more places of interest near the current location point, the algorithm may select places of interest visited more than a predetermined number of times, and assign a confidence score to the selected places based on how many related users visited the candidate place of interest. If multiple places meet a selection criteria, the algorithm may select a predetermined number of places that have been visited (or endorsed or shared) the most by one or more related users (for example, the top three). Where other signals may be non-determinative, the candidate places of interest may be displayed according to the order of their respective rankings.

Another signal may include the global prominence of places proximate (for example, within a predetermined distance) to the current location point. For example, a globally recognized toy store (for example, FAO Schwartz) may be ranked higher than a small local coffee shop in the same geographic location. In determining between the two places, an algorithm may determine a prominence ranking for each place proximate the current location point. A confidence score may be associated with a place of interest based on the prominence ranking. Where other signals may be non-determinative, the candidate place of interest having the highest prominence ranking may be chosen as the place of interested most likely to be visited by the user.

Another signal may include places previously searched for by the user, using for example, an online search engine or search feature implemented by or integrated with a program executed by the device (for example, an operating system). When the user searches for, and selects, an identifiable place, the subject technology may store that place in the user's location history (for example, in a local file system or on a server). The device may then determine whether a determined location point corresponds to a place of interest stored in the location history. A confidence score may be assigned to each identifiable place based on a number of searches for the identifiable place (for example, over a predetermined period of time), the closeness of the search, or the like.

Another signal may include a classification of businesses proximate a determined location point. The classification may include operating hours, a time range of peak traffic, a “morning” or “afternoon” or “evening” designation, or the like. For example, a coffee shop, while open all day and into the evening may have a peak traffic time in the morning. If the current location point is captured near a coffee shop in the morning, and other signals are less indicative of other possible places, the subject technology may provide the coffee shop as a recommendation or place it higher in the list of places recommended to the user for selection. In this example, a predetermined confidence score may be assigned based on how close the current time of day is to the operating hours or peak traffic time of the business.

Another signal may include location recognition from a digital picture (for example, a photo or video). For example, a user may take a digital picture at a time corresponding to the time in which one or more coordinates corresponding to a determined location point were captured. The digital picture may be automatically stored in a local file system or remote server at the time it is taken, or uploaded from the device that captured the digital picture at a later point in time. The subject technology may process the photo using location recognition software and/or hardware and compared against other photos of known places to determine one or more places that likely correspond to the photo, and then present the determined places of interest to the user for selection. Recognition of a place may arise from a visual marker in the photo, for example, a displayed logo, identifiable storefront, or the like. The subject technology may also use a geographic location embedded within meta data stored in connection with the photo (for example, embedded in the digital photo file). The geographic location may be compared against locations of known places to determine one or more candidate places of interest for presentation to the user. A confidence score may be assigned to each candidate place of interest based on how close the recognition software was able to correlate the digital photo to the candidate place of interest, how close the known place of interest is to the geo-location, and/or the like.

The previously described example signals are not inclusive, but, rather, other signals may be included in the same or similar manner. Each candidate place of interest determined by a signal may be associated with a confidence score representative of how likely the candidate place of interest was visited by the user. An overall confidence level may then be calculated from an aggregate of confidence scores corresponding to one or more respective signals. In some aspects, the confidence level may be a weighted average of the determined confidence scores. For example, each signal may be weighted so that when aggregated with other signals, the confidence scores corresponding to higher weighted signals may be given more weight than confidence scores corresponding to lower weighted signals. The confidence level for each candidate place of interest may then be normalized, and the candidate places of interest provided to a user according to their respective confidence levels.

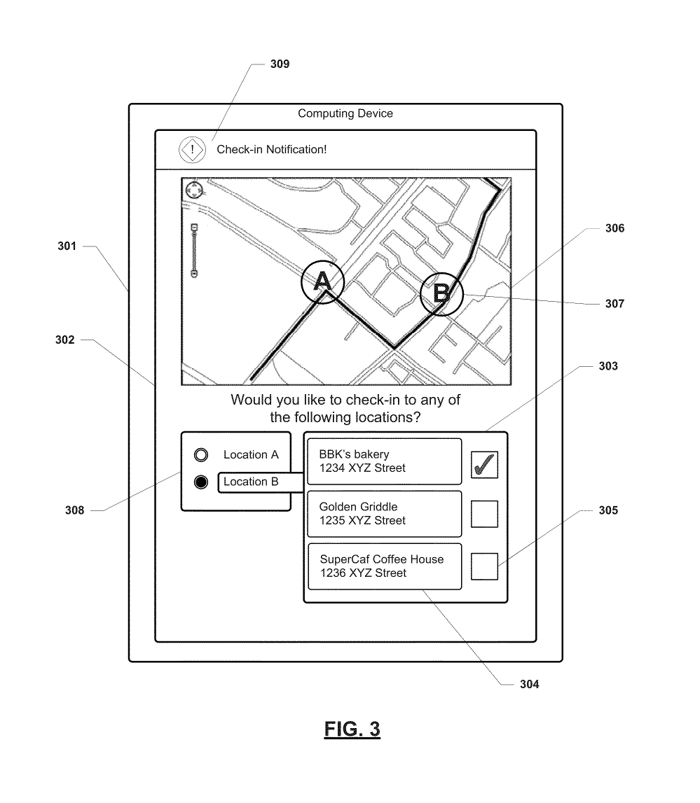

FIG. 3 depicts an example computing device 301, including a user interface 302 for selecting previously visited locations, according to the subject technology. On initiation of user interface 302, a selection list 303 of candidate places may be displayed along with a request for a user to select one or more places from the list that the user visited while on a journey. In one example, each candidate place of interest 304 listed may be associated with a selection box 305 so that the user may select which places were visited and omit other suggestions offered by the system. The selection list may be generated for location points collected over a predetermined period of time (for example, last 24 hours) or a period of time since a previous interaction with the user interface, related to a travelled path of the user that does not include the user's current location, or the like.

In some aspects, user interface 302 may display a graphical map 306, with one or more location points 307 identified, for example, in a travel path. A selection box 308 may be provided for selecting a corresponding location point 307. On selection of an identified location point 307 the system may display (for example, in selection list 303) candidate places of interest 304 corresponding to the selected location point. In other aspects, location points 307 may be selected directly from graphical map 306 (for example, using a pointing device or touch display).

When user interface 302 is not active, computing device 301 may, on being idle for a period of time, display a notification 309 (for example, an alert) to the user, suggesting that the user initiate a command to open the user interface. Notification 309 may also be displayed on unlocking the device (for example, unlocking a smart phone before use), opening up a social networking application, or based on other signals of opportunity.

In one example, a push notification may be sent to the computing device. The notification may prompt the user to open user interface 302, or may ask if the user visited one or more place of interest (for example, selected from a list of candidate places of interest displayed by the notification). On selection of a displayed candidate place of interest, further details of the candidate place of interest may be displayed and/or edited by the user. In another example, after the user has opted-in to the check-in feature of the subject technology, a promo widget may be displayed in connection with a web application used by the user (for example, a graphic box on a webpage of a social network, email service, or the like). The promo widget may display one or more random text promos asking the user “were you at this place?” If the user selects a text promo or otherwise selects “yes” then the system may automatically check the user into that place of interest. The system may then display another text promo for another candidate place of interest in the previously described list of candidate places of interest. On selection of one or more candidate places of interest (for example, from the previously described list), the system may perform a check-in operation and/or post one or messages to a message stream of a social network, informing other users that the user visited the one or more candidate places of interest.

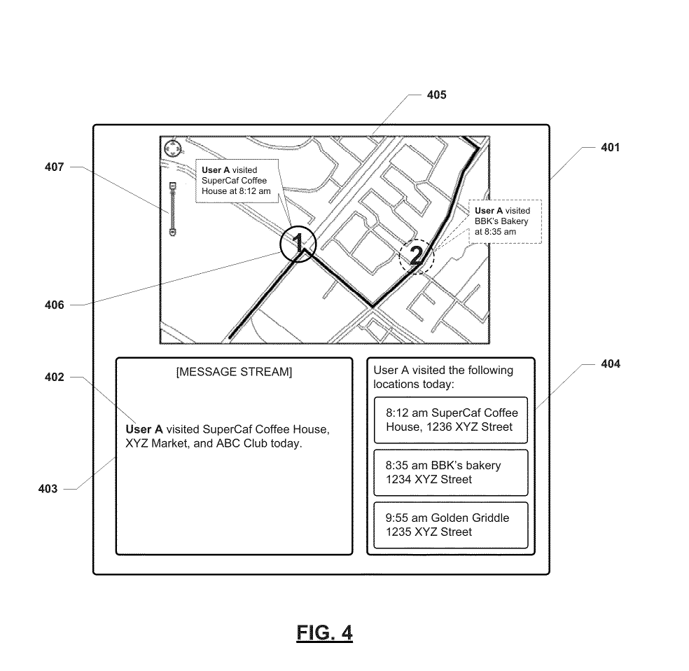

FIG. 4 depicts a webpage 401, including example alternative viewing mechanisms for displaying locations previously visited by a user in a social network, according to the subject technology. In one example, the previously described selected places of interest may be displayed as one or more messages 402 in a message stream 403. The one or more messages 402 may be displayed in the message stream at a time corresponding to a time that the user visited the place of interest, or, as depicted, may be grouped together, informing users that, for example, the user “visited [Place A], [Place B], and [Place C].” In another example, webpage 401 (for example, displayed by the social network) may display the selected places of interest in a list view 404 (for example, as a widget). In another example, the webpage, or list view 404, may display a text-base or graphical timeline that displays user visits (“check-ins”) over time.

In another example, an electronic map 405 (for example, heat map) may be provided that displays each visited place of interest as an identified location 406 (for example, a spot) on the map. In one aspect, electronic map 405 may be associated with an interactive repositionable graphic bar 407 (for example, a time scrubber) that, on a repositioning of the graphic bar by a pointing device, causes electronic map 405 to limit the display of the one or more locations 406 to only places visited during a time period corresponding to a current positioning of the graphic bar. In this regard, the user may use graphic bar 407 to scrub back and forth through time and see which places of interest the user visited at different times. For example, location “2” is displayed in dashed lines to illustrate that it may not be displayed until a user repositions graphic bar 407 to a time period associated with the location.

While the previously described viewing mechanisms are displayed together in the depicted example webpage 401, it should be understood that many implementations of webpage 401 may display only one mechanism. For example, a social network may display the locations grouped together in a message stream visible on one webpage, but display either the previously described electronic map or list view on one or more other webpages.

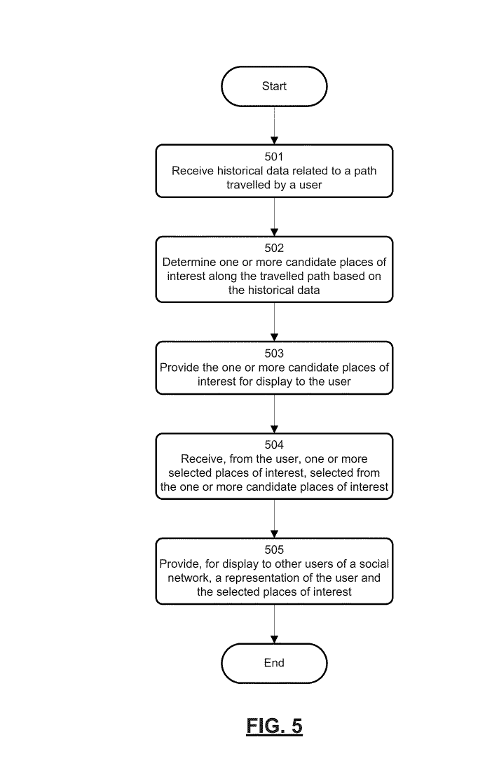

FIG. 5 is a flowchart illustrating an example process for sharing previously visited locations in a social network according to one aspect of the subject technology. In block 501, historical travel data related to a path travelled by a user is received. The historical travel data may include, for example, position information (including, for example, coordinate readings) recorded by a location-aware mobile computing device (for example, up to, but not including a current location of the user). The travelled path may be determined by, or representative of, the historical travel data. The historical travel data may be received and processed by software or hardware integrated with the mobile device, or sent by the mobile device and received and processed at a server by software or hardware integrated with the server.

In block 502, one or more candidate places of interest along the travelled path are determined based on the historical travel data. For example, the one or more candidate places of interest may be determined based on one or more geographic locations along the path where the user paused for at least a predetermined duration (for example, more than five minutes). In another example, the historical travel data may include a plurality of geographic coordinate readings. In this regard, one or more candidate places of interest may be determined based on a selection of known places of interest proximate to one or more respective clusters of the geographic coordinate readings. Additionally or in the alternative, the candidate places of interest may be determined based on one or more signals, each signal providing an indication that the user visited a respective place of interest

In block 503, the one or more candidate places of interest are provided for display to the user. In this regard, a user interface may display the one or more candidate places of interest to the user, and request that the user select one or more of the candidate places of interest. In block 504, one or more selected places of interest, selected from the one or more candidate places of interest is received from the user. On receiving the one or more selected places of interest, in block 505, a representation of the user and the selected places of interest (for example, a character description of the one or more selected places of interest together with a user identifier such as the user's name, picture, or other likeness of the user) is provided for display to other users of a social network (for example, in a message stream).

FIG. 6 is a diagram of an example system 600 and related devices for sharing previously visited locations in a social network according to one aspect of the subject technology. System 600 may include one or more servers 601 configured to host an online social network and provide web pages related to the online social network over a network 602 (for example, a local or wide area network, Wi-Fi network, cellular network, the Internet, or the like). Servers 601 may be in operable communication (for example, connected over network 602) with one or more computing devices 603 or 604. In some aspects, computing device 603 may be a geographically aware mobile device (for example, a smart phone, tablet or notebook computer, personal computer, PDA, or the like).

Servers 601 may be configured to provide one or more application programming interfaces (APIs) for the integration of mobile-to-web extension applications. For example, a social network hosted by servers 601 may include a social check-in application that allows users of the social network to “check in” to a physical place using computing device 603, and share their location with their friends or contacts. Device 603 may be configured with software integrated with the social network, that is configured to perform a check-in by associating one or more specific places of interest (for example, places, businesses or recreational areas, or the like) with a user's current geographic location. The software may use a GPS device integrated into the computing device to find the user's current location, and then present to the user for selection a list of places of interest based on the current location. Other methods of determining a user's location may include multilateration of radio signals between (several) radio towers of the network and the phone, mobile positioning, signal interpolation, and the like. When a place of interest is selected, the computing device may send a message (for example, over network 602) to servers 601 to supplement the user's current geographic location displayed in the social network with the selected place of interest.

In one aspect, servers 601 may be configured to provide for display a graphical user interface 605 (for example, user interface 302) for communicating with a first user 606 and for selecting previously visited locations. User interface 605 may display candidate places of interest determined from a travel path of first user 606. In the depicted example, servers 601 may receive a plurality of coordinate readings related to a path previously travelled by a user. Servers 601 may then determine one or more candidate places of interest based on the plurality of coordinate readings. The one or more candidate places of interest may then be provided for display at user interface 605 for display to first user 606. First user 606 may select one or more of the candidate places of interest to convey that first user 606 visited the selected places of interest when first user 606 travelled along the travel path.

Computing device 604 (for example a smartphone, GPS navigation device, or personal computer, tablet computer, PDA, a television or other display device with one or more computing devices embedded therein or attached thereto, or other device configured to determine a present location of a user) may provide a second user interface 607 (for example, webpage 401) for displaying locations previously visited by one or more first users 606. On receiving the previously described selected places of interest from a first user 606 at user interface 605, servers 601 may provide user interface 607 a representation of first user 606 and the one or more selected places of interest. The representation may include, for example, a character-based message displayed in a message stream associated with the social network.

In some aspects, the various connections between servers 601, computing devices 603 and 604, and/or network 602 may be made over a wired or wireless connection. The functionality of servers 601 may be implemented on a single server or distributed among a plurality of servers or other computing devices. The functionality of server 601 may also be included in computing devices 603 and/or 604 such that an independent server or set of servers is not necessary to carry out the aspects of the subject technology, but, rather, may be implemented by a system of one or more distributed computing devices.

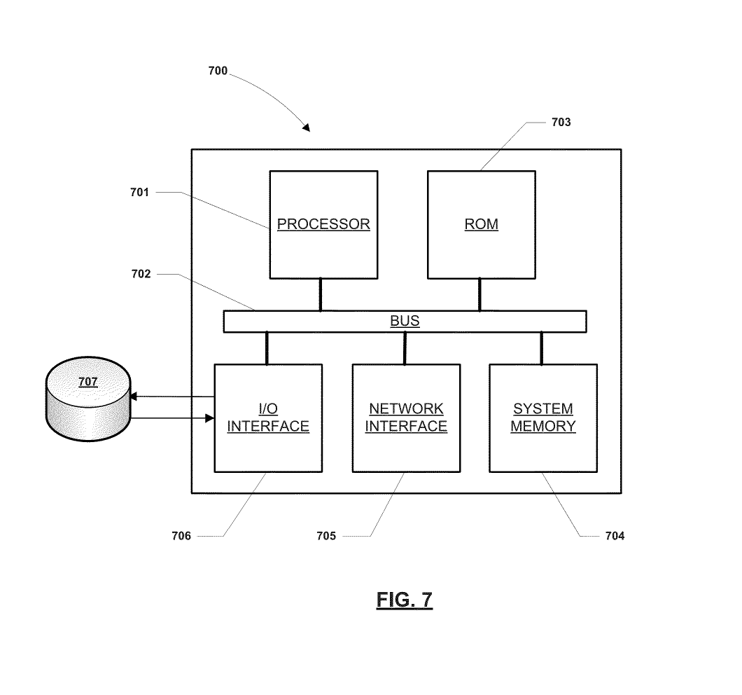

FIG. 7 is a diagram illustrating an example computing system for sharing previously visited locations in a social network, including a processor and other internal components, according to one aspect of the subject technology. In some aspects, a computing device 700 (for example, a server 601, computing device 602 or 603, or the like) includes several internal components such as a processor 701, a system bus 702, read-only memory 703, system memory 704, network interface 705, I/O interface 706, and the like. In one aspect, processor 701 may also be communication with a storage medium 707 (for example, a hard drive, database, or data cloud) via I/O interface 706. In some aspects, all of these elements of device 700 may be integrated into a single device. In other aspects, these elements may be configured as separate components.

Processor 701 may be configured to execute code or instructions to perform the operations and functionality described herein, manage request flow and address mappings, and to perform calculations and generate commands. Processor 701 is configured to monitor and control the operation of the components in server 700. The processor may be a general-purpose microprocessor, a microcontroller, a digital signal processor (DSP), an application specific integrated circuit (ASIC), a field programmable gate array (FPGA), a programmable logic device (PLD), a controller, a state machine, gated logic, discrete hardware components, or a combination of the foregoing. One or more sequences of instructions may be stored as firmware on a ROM within processor 701. Likewise, one or more sequences of instructions may be software stored and read from ROM 703, system memory 704, or received from a storage medium 707 (for example, via I/O interface 706). ROM 703, system memory 704, and storage medium 707 represent examples of machine or computer readable media on which instructions/code may be executable by processor 701. Machine or computer readable media may generally refer to any medium or media used to provide instructions to processor 701, including both volatile media, such as dynamic memory used for system memory 704 or for buffers within processor 701, and non-volatile media, such as electronic media, optical media, and magnetic media.

In some aspects, processor 701 is configured to communicate with one or more external devices (for example, via I/O interface 706). Processor 701 is further configured to read data stored in system memory 704 and/or storage medium 707 and to transfer the read data to the one or more external devices in response to a request from the one or more external devices. The read data may include one or more web pages and/or other software presentation to be rendered on the one or more external devices. The one or more external devices may include a computing system such as a personal computer, a server, a workstation, a laptop computer, a tablet computer, a television with one or more processors embedded therein or coupled thereto, PDA, smart phone, and the like.

In some aspects, system memory 704 represents volatile memory used to temporarily store data and information used to manage device 700. According to one aspect of the subject technology, system memory 704 is random access memory (RAM) such as double data rate (DDR) RAM. Other types of RAM also may be used to implement system memory 704. Memory 704 may be implemented using a single RAM module or multiple RAM modules. While system memory 704 is depicted as being part of device 700, those skilled in the art will recognize that system memory 704 may be separate from device 700 without departing from the scope of the subject technology. Alternatively, system memory 704 may be a non-volatile memory such as a magnetic disk, flash memory, peripheral SSD, and the like.

I/O interface 706 may be configured to be coupled to one or more external devices, to receive data from the one or more external devices and to send data to the one or more external devices. I/O interface 706 may include both electrical and physical connections for operably coupling I/O interface 706 to processor 701, for example, via the bus 702. I/O interface 706 is configured to communicate data, addresses, and control signals between the internal components attached to bus 702 (for example, processor 701) and one or more external devices (for example, a hard drive). I/O interface 706 may be configured to implement a standard interface, such as Serial-Attached SCSI (SAS), Fiber Channel interface, PCI Express (PCIe), SATA, USB, and the like. I/O interface 706 may be configured to implement only one interface. Alternatively, I/O interface 706 may be configured to implement multiple interfaces, which are individually selectable using a configuration parameter selected by a user or programmed at the time of assembly. I/O interface 706 may include one or more buffers for buffering transmissions between one or more external devices and bus 702 and/or the internal devices operably attached thereto.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that the specific order or hierarchy of steps in the processes disclosed is an illustration of example approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

The term website, as used herein, may include any aspect of a website, including one or more web pages, one or more servers used to host or store web related content, and the like. Accordingly, the term website may be used interchangeably with the terms web page and server. The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a “configuration” may refer to one or more configurations and vice versa.

The word “example” is used herein to mean “serving as an example or illustration.” Any aspect or design described herein as “example” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

1. A computer-implemented method for sharing previously visited locations with users in a social network, the method comprising:
receiving historical travel data related to a path travelled by a user;
determining one or more candidate places of interest along the travelled path based on a time in the historical travel data corresponding to the one or more candidate places and operating hours for the candidate places;
providing the one or more candidate places of interest for display to the user;
receiving, from the user, one or more selected places of interest, selected from the one or more candidate places of interest; and
providing, for display to other users of a social network, a representation of the user and the selected places of interest.

2. The computer-implemented method of claim 1, wherein determining the one or more candidate places of interest comprises:
determining one or more geographic locations along the travelled path where the user paused for at least a predetermined duration.

3. The computer-implemented method of claim 1, wherein the historical travel data includes a plurality of geographic coordinate readings, the method further comprising:
determining at least one of the one or more candidate places of interest based on one or more respective clusters of geographic coordinate readings; and
determining the one or more candidate places of interest from places of interest proximate to the one or more location places.

4. The computer-implemented method of claim 1, further comprising:
determining the one or more candidate places of interest based on one or more signals, each signal providing an indication that the user visited a respective place of interest.

5. The computer-implemented method of claim 1, further comprising:
determining at least one of the one or more candidate places of interest based on one or more recorded past visits to the at least one candidate places of interest.

6. The computer-implemented method of claim 1, further comprising:
determining at least one of the one or more candidate places of interest based on one or more recorded past visits to places of interest having one or more classifications associated with the at least one candidate places of interest.

7. The computer-implemented method of claim 1, further comprising:
determining at least one of the one or more candidate places of interest based on the at least one candidate places of interest being associated with one or more other users in a social graph with the user.

8. The computer-implemented method of claim 1, further comprising:
determining at least one of the one or more candidate places of interest based on a prominence associated with the at least one candidate places of interest.

9. The computer-implemented method of claim 1, further comprising:
determining at least one of the one or more candidate places of interest based on one or more prior online searches, by the user, for information related to the at least one candidate places of interest.

10. The computer-implemented method of claim 1, further comprising:
determining at least one of the one or more candidate places of interest based on a determination that the user was at the at least one candidate places of interest during a predetermined time of day.

11. The computer-implemented method of claim 1, further comprising:
receiving one or more digital pictures; and
determining at least one of the one or more candidate places of interest based on one or more geographic locations associated with the one or more digital pictures.

12. The computer-implemented method of claim 1, further comprising:
receiving one or more digital pictures; and
determining at least one of the one or more candidate places of interest based on a visual recognition of at least a portion of the one or more digital pictures.

13. The computer-implemented method of claim 1, wherein the representation is provided as one or more posts to a message stream.

14. The computer-implemented method of claim 1, wherein the representation is provided as an electronic map, with the one or more selected places of interests displayed as one or more respective locations on the map, the map associated with an interactive repositionable graphic, that on repositioning of the graphic by a pointing device, causes the map to limit the display of the one or more selected places of interests to places visited during a time period corresponding to a current positioning of the graphic.

15. The computer-implemented method of claim 1, further comprising:
providing, to the user, a notification that the one or more candidate places of interest are available for selection by the user; and
receiving, from the user in response to the notification, an indication to review the candidate places of interest,
wherein the one or more candidate places of interest are provided for display, on receiving the indication, at a user interface.

16. A non-transitory machine-readable medium having instructions stored thereon that, when executed, cause a machine to perform a method of sharing previously visited locations with users in a social network, the method comprising:
receiving a plurality of geographic coordinate readings recorded over a period of time, the plurality of geographic coordinate readings being related to a path travelled by a user;
determining one or more candidate places of interest based on a time in the plurality of geographic coordinate readings corresponding to the one or more candidate places and operating hours for the candidate places;
providing the one or more candidate places of interest for display at a first user interface;
receiving, from the first user interface, one or more selected places of interests; and
providing, for display at a second user interface, a representation of the one or more selected places of interest and a user who visited the one or more selected places of interest

17. The non-transitory machine-readable medium of claim 16, further comprising:
determining at least one of the one or more candidate places of interest based on one or more clusters of geographic coordinate readings.

18. The non-transitory machine-readable medium of claim 16, further comprising:
determining the one or more candidate places of interest based on one or more signals, each signal providing an indication that the user visited a respective place of interest.

19. The non-transitory machine-readable medium of claim 16, wherein the representation is displayed in a message stream.

20. A system, comprising:
a processor; and
a memory including instructions that, when executed by the processor, cause the processor to facilitate the steps of:
receive a plurality of coordinate readings related to a path travelled by a user;
determine one or more candidate places of interest along the travelled path based on a time in the plurality of coordinate readings corresponding to the one or more candidate places and operating hours for the candidate places;
provide the one or more candidate places of interest for display at a user interface;
receive, from the user interface, one or more selected places of interest; and
provide, for display to other users of a social network, a representation of the user and the one or more selected places of interest.
